(19) United States
(12) Patent Application Publication
(10) Pub. No.: US 2015/0193905 A1
(43) Pub. Date: Jul. 9, 2015

(54) DATA PROCESSING METHOD AND DISPLAY DEVICE USING THE SAME

(71) Applicant: SAMSUNG DISPLAY CO., LTD., Yongin-City (KR)

(72) Inventors: Ji Gong Lee, Cheonan-si (KR); Min Seok Bae, Asan-si (KR); Su Min Yang, Goyang-si (KR)

(21) Appl. No.: 14/579,915

(22) Filed: Dec. 22, 2014

(30) Foreign Application Priority Data
Jan. 3, 2014 (KR) 10-2014-0000787

(51) Int. Cl. G06T 1/20

(52) U.S. Cl. CPC G06T 1/20

(57) ABSTRACT

A method of processing data in a display device for displaying an image is disclosed. In one aspect, the method includes: dividing the data elements of an image data into sections based on the distribution of the data elements; then generating a header for each section; compressing each data element to a compressed data element by using an offset specific to the section including the data element, an interval of the section including the data element and the header for that section; and generating an image data signal for displaying the image using the compressed data element.

### CROSS-REFERENCE TO RELATED APPLICATIONS

This application claims priority under 35 U.S.C. §119 to Korean Patent Application No. 10-2014-0000787 filed in the Korean Intellectual Property Office on Jan. 3, 2014, the entire content of which is incorporated herein by reference.

### BACKGROUND

1. Field

The described technology generally relates to a data processing method in a display device and a display device using the same method; particularly, to a data processing method and a display device using the same method for compressing image data and restoring the compressed image data in order to display an image.

2. Description of the Related Technology

In order to efficiently use the capacity of a recording medium for recording data and easily transfer data, various data processing technologies for compressing data and restoring the compressed data have been used in most electronic devices.

In general, compressing data at a high compression rate requires complex circuitry and procedures which slow the compression speed. Compressing data at a low compression rate may achieve a faster processing speed and require relatively simple circuitry and procedures for compression. The same is true for restoring compressed data.

Accordingly, a data processing method for increasing the compression rate of data while decreasing complexity and processing time in hardware and software is desired.

An active matrix organic light emitting diode (AMOLED) display, in which the diode is selected for each unit pixel to emit light, is a main organic light emitting diode display among the flat panel display devices for resolution, contrast, and operation speed.

A light emission level of the organic light emitting diode in one pixel of the active matrix OLED (hereinafter referred to as an organic light emitting diode display) is adjusted by controlling a driving transistor supplying a driving current according to a data voltage to the organic light emitting diode.

The organic light emitting diode may deteriorate over time. The deteriorating organic light emitting diode may exhibit a decrease in luminance even though the current flow compared to the organic light emitting diode before the deterioration remains unchanged. For example, the organic light emitting diode emitting light for about 50,000 hours may emit light with luminance corresponding to about 37% of luminance at an initial stage. Therefore, as the organic light emitting diode deteriorates, displaying an image with desired luminance is needed.

### SUMMARY OF CERTAIN INVENTIVE ASPECTS

Embodiments are disclosed of a data processing method, in for example a display device, for increasing compression rate when compressing data, while decreasing complexity and processing time both in hardware and software.

Further, embodiments relate to a display device for displaying an image with uniform luminance even though a pixel deteriorates.

One aspect relates to a method of processing data in a display device for displaying an image. The method includes: dividing a plurality of data elements into a plurality of sections according to a distribution of the plurality of data elements; generating a header corresponding to a section including a data element; compressing the data element to a compressed data element by using an offset corresponding to the section including the data element and an interval of the section including the data element.

In one aspect, the dividing of the plurality of data elements into the plurality of sections may include: selecting a reference value from the distribution of the plurality of data elements; setting an interval of the section according to a degree of the distribution of the plurality of data elements; and dividing the plurality of data elements into the plurality of sections according to the set interval of the section from the reference value.

The reference value may be a value corresponding to an average value of the distribution of the data elements or a value corresponding to a maximum value of the distribution of the data elements.

In another aspect, the dividing of the plurality of data elements into the plurality of sections may include dividing the plurality of data elements into the plurality of sections by choosing the reference value according to a compression rate of the data element.

In another aspect, the dividing of the plurality of data elements into the plurality of sections may include dividing the plurality of data elements into the plurality of sections by choosing the interval according to a compression rate of the data element.

In another aspect, the dividing of the plurality of elements of data into the plurality of sections may include: choosing the interval such that the intervals of sections with larger data element distribution are smaller than the intervals of sections with smaller data element distribution.

In another aspect, the compressing of the data element into the compressed data element may include dividing a difference between a value of the data element and the offset by the interval of the section including the data element.

In another aspect, the method may further include storing the compressed data element such that the compressed data element is related to the header.

In another aspect, the method may further include: determining the offset and the interval of the section from the header; and restoring the data element by using a value of the compressed data element related to the header, offset, and the interval of the section including the data element corresponding the compressed data element.

In another aspect, the restoring of the data element may include restoring the data element by adding the offset to a value obtained by multiplying a value of the compressed data element and the interval of the section including the data element corresponding to the compressed data element.

In another embodiment a display device is provided. The display device may include: a display unit including a plurality of pixels emitting light according to a plurality of data signals; a data driver configured to transmit the data signals through a plurality of data lines connected to the plurality of pixels; a power source voltage supply unit configured to supply a driving voltage for driving the plurality of pixels through power source wires connected to the plurality of pixels; a compensation memory unit configured to store one or more compressed data streams related to compensation data for each of the plurality of pixels; a memory unit configured to store data for restoring the data stream; and a controller configured to generate the data signal by receiving an image signal, determining a header field from the compressed data stream, determining a value of the header field, reading from the memory unit, data for restoring a compressed data field corresponding to the header field; restoring the compensation data, and compensating the image signal and generating the data signal by using the restored compensation data.

In one aspect, the data for restoring the compressed data may include offset data corresponding to the header field and section interval data corresponding to the header field.

In another aspect, the controller may restore the compensation data by adding the offset to a value obtained by multiplying a value corresponding to the compressed data stream and the section interval.

In another aspect, the compressed data stream may be compressed by dividing the compensation data into a plurality of sections according to a distribution of the compensation data, generating the header field corresponding to the section including the compensation data, and choosing an offset corresponding to the section including the compensation data and an interval of the section including the compensation data.

In another aspect, the compensation data may be divided into the plurality of sections according to section intervals obtained using a reference values, wherein the reference value is determined from the distribution of the compensation data, and section intervals are set according to a degree of the distribution of the compensation data.

In another aspect, the reference value may be a value corresponding to an average value of the distribution of the compensation data or a value corresponding to a maximum value of the distribution of the compensation data.

In another aspect, the compensation data may be divided into the plurality of sections by choosing the reference value according to a compression rate of the compensation data.

In another aspect, the compensation data may be divided into the plurality of sections by choosing the interval of the section according to a compression rate of the compensation data.

In another aspect, the compensation data may be divided into the plurality of sections by choosing the interval such that the intervals of sections with smaller distribution of the compensation data are larger than the intervals of sections with larger distribution of the compensation data.

Using these exemplary embodiments, it is possible to advantageously increase the data compression rate in a display device.

Using these exemplary embodiments, it is possible to easily restore compressed data in a display device.

Using these exemplary embodiments in a display device, it is possible to provide an image with uniform luminance despite pixel deterioration.

### BRIEF DESCRIPTION OF THE DRAWINGS

FIG. 1 is an example of non-compressed data that is processed by a data processing method in a display device according to an exemplary embodiment.

FIG. 2 is a flowchart illustrating a process of compressing data by the data processing method in a display device according to an exemplary embodiment.

FIG. 3 is a sample graph illustrating a distribution of the original data in a display device according to an exemplary embodiment.

FIG. 4 is an example of data compressed by the data processing method in a display device according to an exemplary embodiment.

FIG. 5 is a flowchart illustrating a process of restoring the compressed data by a data processing method in a display device according to an exemplary embodiment.

FIG. 6 is a block diagram schematically illustrating a configuration of a display device according to an exemplary embodiment.

FIG. 7 is a circuit diagram illustrating an example of a pixel structure included in a display unit of the display device according to the exemplary embodiment of FIG. 6.

### DETAILED DESCRIPTION OF CERTAIN INVENTIVE EMBODIMENTS

Example embodiments will now be described more fully hereinafter with reference to the accompanying drawings. However, the described embodiments may be embodied in different forms and should not be construed as limited to the embodiments set forth herein. Rather, these embodiments are provided so that this disclosure will be thorough and complete and will fully convey the scope of the described technology to those skilled in the art.

In the figures, dimensions may be exaggerated for clarity of illustration. It will be understood that when an element is referred to as being “between” two elements, it can be the only element between the two elements, or one or more intervening elements may also be present.

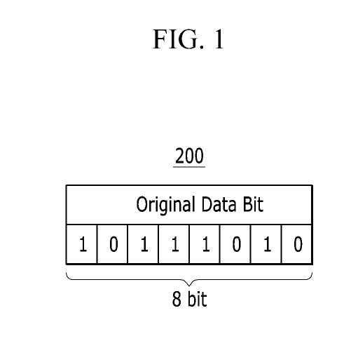

FIG. 1 illustrates an example of non-compressed data 200 included in original data processed by a data processing method according to an exemplary embodiment. As illustrated in FIG. 1, the non-compressed data 200 may be a value formed of 8 bits.

The original data may include one of the following non-compressed data values.

For example, the original data may be look-up table (LUT) data including at least one non-compressed data value. In this case, the non-compressed data 200 included in the LUT data may be compensation data corresponding to a plurality of pixels included in a display device.

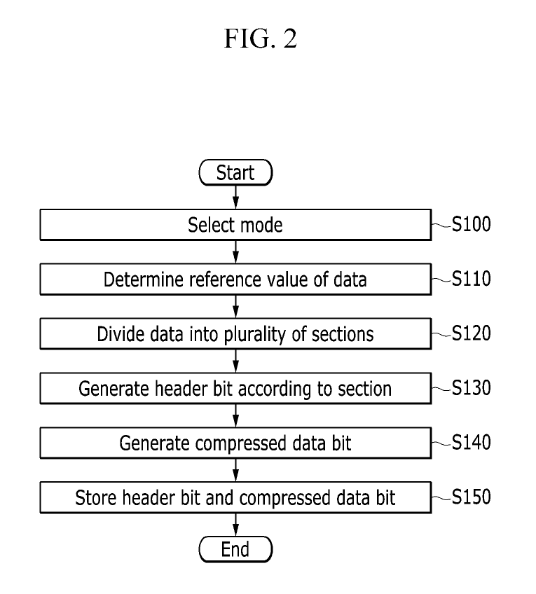

Next, a method of compressing data for displaying an image in a display device will be described with reference to FIG. 2.

FIG. 2 is a flowchart illustrating a process of compressing data by a data processing method according to an exemplary embodiment. The compression of the original data by the data processing method may be implemented within a recording medium readable by a computer or a device similar to the computer by using software, hardware, or a combination of software and hardware.

Depending on the hardware implementation, the exemplary embodiments described herein may be implemented using any of the following: application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electrical units for performing other functions. In some cases, the exemplary embodiments described in the present specification may be implemented by a controller of a display device. Hereinafter, the present disclosure will be based on an assumption that the controller compresses the original data, but other elements may also compress the original data.

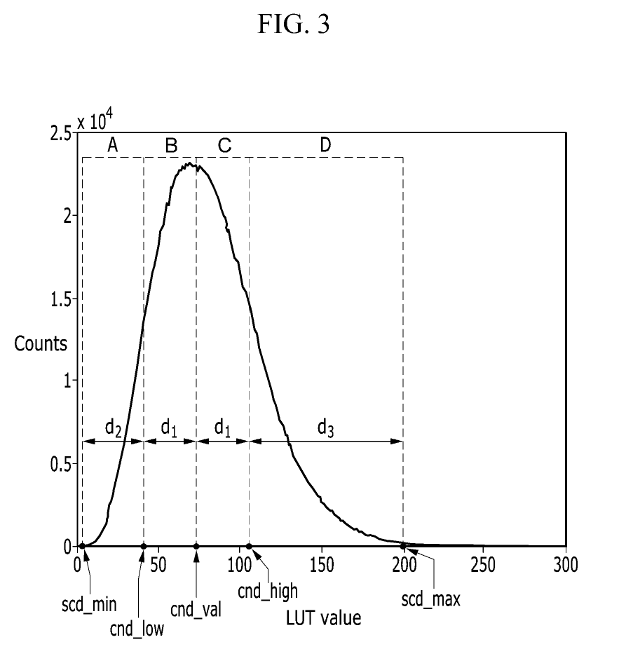

First, the controller selects a data compression mode according to a distribution of non-compressed data values in the original data (S100). Referring to FIG. 3, the distribution of the non-compressed data in the original data will be described.

FIG. 3 is a graph illustrating a distribution of the non-compressed data in the original data. The horizontal axis of the graph may represent values of the non-compressed data elements in the original data, and the vertical axis may represent the number of non-compressed data elements.

As illustrated in FIG. 3, the distribution of the non-compressed data may have at least one peak. The peak may be an inflection point at which a variation of the number of elements of the non-compressed data having the same data value changes. The distribution of the non-compressed data may have a plurality of peaks according to the characteristics of the non-compressed data.

Hereinafter, the embodiments will be described based on an assumption that the distribution of the non-compressed data has one peak; however, the embodiments are equally applicable to non-compressed data having more than one peak.

According to the distribution of the non-compressed data, a data compression mode may be selected. The data compression mode will be described later.

The controller selects a reference value from the original data (S110). For example, the reference value from the original data may be selected to be the value cnd_val of the non-compressed data corresponding to the peak shown in FIG. 3. When there is more than one peak, the controller may select a number of reference values from the original data. The controller may then select an average value of the reference values or an intermediate value of the non-compressed data value to be the reference value of the original data.

When the reference value is determined, the controller divides the non-compressed data into a plurality of sections (S120). For example, as illustrated in FIG. 3, the non-compressed data may be divided into section A, section B, section C, and section D. Section B may be a section of data values obtained by subtracting a first data value from the reference value, and section C may be a section of data values obtained by adding the first data value to the reference value. Section B and section C may be sections in which the non-compressed data is concentrated, and hereinafter, are described as center data sections.

In the case shown in FIG. 3, the first data value may be set according to a section in which the data is concentrated, that is, a data concentration degree around the reference value. For example, the first data value may have a smaller value in the case where the distribution of the data is small compared to a case where the distribution of the data is large. Then, an interval of the center data section may be further decreased in a case where the distribution is small.

Section A may be a section from a lower limit value of the non-compressed data to a lower limit value of the center data section, and section D may be a section from an upper limit value of the center data section to an upper limit value of the non-compressed data. Hereinafter, section A and section D will be described as peripheral data sections.

In the above description, the non-compressed data is divided into four sections according to the reference value, but the number of sections may be changed according to the characteristics of the distribution of the non-compressed data.

Next, the controller generates a header corresponding to the plurality of sections (S130). For example, the header can contain 2 bits of data.

For example, the header referring to the non-compressed data in section A may be 11, the header referring to the non-compressed data in section B may be 10, the header referring to the non-compressed data in section C may be 00, and the header referring to the non-compressed data in section D may be 01.

The controller can generate a bit of the compressed data by using the plurality of values of the non-compressed data (S140). For example, the compressed data may use 4 bits. Other compression rates may also be used, for example, the compressed data may use 2 to 5 bits. For example, when the data is compressed with a high compression rate, the compressed data may use 2 bits, but when the data is compressed with a low compression rate, the compressed data may use 5 bits.

The bits of the compressed data may be calculated and generated according to Equation 1 below.

$${DATA}_{COMP} = \frac{{DATA}_{RAW} - OFFSET}{{INT}_{COMP}} \qquad ( Equation 1 )$$

DATA_{COMP} may be a value of the compressed data, DATA_{RAW} may be a value of the non-compressed data, OFFSET may be a lower limit value of a section including the non-compressed data generated with the bits of the compressed data, and INT_{COMP} may be an interval of a section including the non-compressed data.

For example, in a case where the non-compressed data is included in section C, OFFSET may be the reference value and INT_{COMP} may be an interval from the reference value to an upper limit value of the center data section.

Next, the controller stores the compressed data so that the header corresponding to the value of the non-compressed data corresponds to the bit of the compressed data in which the values of the non-compressed data are compressed (S150).

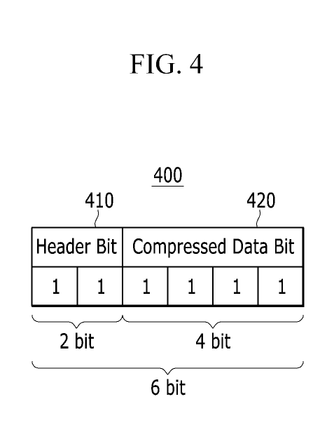

This will be described with reference to FIG. 4.

FIG. 4 is illustrating an example of a format of data compressed by the method according to the exemplary embodiment. As illustrated in FIG. 4, a compressed data format 400 may include a header and compressed data bits. For example, the compressed data format 400 includes a header 410 of 2 bits and compressed data bits 420 of 4 bits to be formed of a total of 6 bits.

A value according to a section in which the original data is included may be stored in the header 410. A value obtained by compressing the original data value may be stored in the compressed data bits 420 as described in step S140.

The number of bits of the header 410 may be determined according to the number of sections into which the original data is divided. For example, when the original data is divided into four sections, the number of bits of the header 410 is 2.

The number of bits of the compressed data bits 420 may be determined according to the compression rate. For example, the number of bits of the compressed data bits 420 in a case where the compression rate is high has a smaller value than the number of bits of the compressed data bits 420 in a case where the compression rate is low.

It is assumed that the aforementioned data processing method is a method of compressing the data by a first data compression mode.

A second data compression mode is similar to the first data compression mode, but may be a mode in which the non-compressed data is divided into section A to section D so that section A to section D have the same interval according to the distribution of the original data, section A is moved to section B in parallel by a lower limit value of the center data section, and section D is moved to section C in parallel by a lower limit value of the center data section to perform compression.

A third data compression mode is similar to the second data compression mode, but may be a mode of performing compression by setting intervals of section A and section D to be wider than intervals of section B and section C.

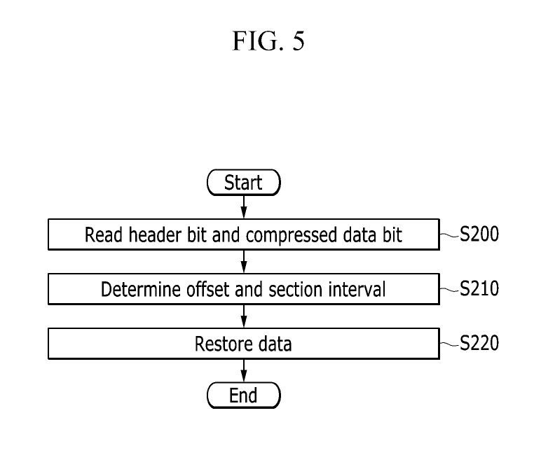

Next, a method of restoring the compressed data will be described with reference to FIG. 5.

FIG. 5 is a flowchart illustrating a process of restoring compressed data by the data processing method according to the exemplary embodiment.

First, the controller reads a header and associated compressed data bits (S200).

For example, when the compressed data is formed of a data stream, and the compressed data format is formed of 6 bits, the controller may classify the data stream in the unit of 6 bits and determine that the first 2 bits of the data stream are the header bits, and determine that the remaining 4 bits after the header bits are the compressed data bits corresponding to the header bits. Then, the controller may determine that the 2 bits after the compressed data bits are the next header bits and so forth.

The controller determines an offset and a section interval according to the value of the header bits (S210). The controller may determine a value of an offset and a section interval corresponding to the read header bits by using a value of an offset and a section interval value corresponding to a header value of pre-stored compressed data.

Next, the controller restores the compressed data bits by using the value of the offset and the section interval (S220). For example, the controller may restore the compressed data bits by using Equation 2 below.

DATA_{DECOMP}=(DATA_{COMP}×INT_{COMP})+OFFSET (Equation 2)

DATA_{DECOMP} may be a value of the restored data, DATA_{COMP} may be a value of the compressed data bit, OFFSET may be an offset value corresponding to the header, and INT_{COMP} may be an interval of a section corresponding to the header.

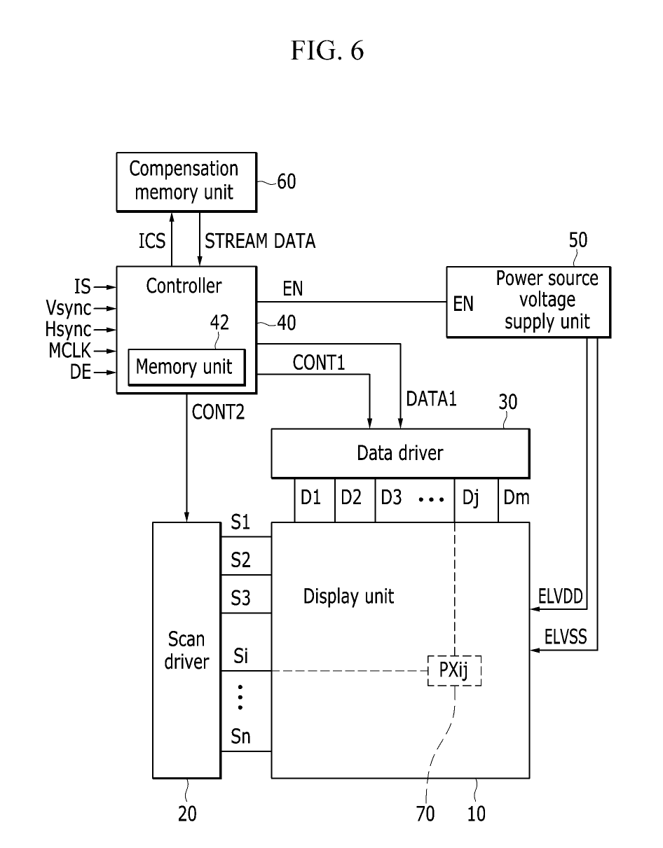

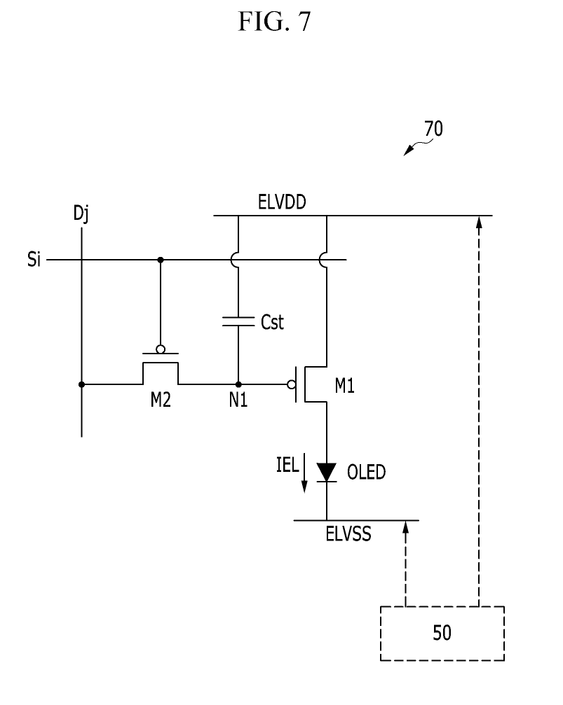

Hereinafter, a display device for restoring the compressed data and using the restored data by the aforementioned data processing method will be described with reference to FIGS. 6 and 7.

As a non-limiting example, the data processing method described above can be used to compress data used for compensating for deterioration of the organic light emitting diode. However, the compressed data may be data in which at least one piece of information for driving the display device is compressed, and is not limited to a description below. For ease of description, it is assumed that the compressed data is in the form of a data stream.

FIG. 6 is a block diagram schematically illustrating a configuration of a display device according to an exemplary embodiment. As illustrated in FIG. 6, the display device includes a display unit 10 including a plurality of pixels 70, a scan driver 20, a data driver 30, a controller 40, a memory unit 42, a power source voltage supply unit 50, and a compensation memory unit 60 in which information (hereinafter referred to as “deterioration compensation information”) for compensating for deterioration of the organic light emitting diode included in each of the plurality of pixels 70 is stored in the form of a data stream.

The display unit 10 is a display panel including a plurality of pixels 70 connected to corresponding scan lines among a plurality of scan lines S1 to Sn, and corresponding data lines among a plurality of data lines D1 to Dm. Each of the plurality of pixels displays an image so as to correspond to an image data signal transmitted to a corresponding pixel.

Each of the plurality of pixels included in the display unit 10 is connected to the plurality of scan lines S1 to Sn and the plurality of data lines D1 to Dm, to be approximately arranged in a form of a matrix. The plurality of scan lines S1 to Sn is approximately extended in a row direction to be almost parallel to each other. The plurality of data lines D1 to Dm are approximately extended in a column direction to be almost parallel to each other. Each of the plurality of pixels of the display unit 10 receives a power source voltage from the power source voltage supply unit 50, and receives a first driving voltage ELVDD and a second driving voltage ELVSS.

The scan driver 20 is connected to the display unit 10 through the plurality of scan lines S1 to Sn. The scan driver 20 generates a plurality of scan signals capable of activating each pixel of the display unit 10 according to a scan control signal CONT2 and transmits the generated scan signals to the corresponding scan lines among the plurality of scan lines S1 to Sn.

The scan control signal CONT2 is an operation control signal of the scan driver 20 generated and transmitted by the controller 40. The scan control signal CONT2 may include a scan start signal SSP, a clock signal CLK, and the like. The scan start signal SSP is a signal for generating a first scan signal for displaying an image of one frame. The clock signal CLK is a synchronization signal for sequentially applying the scan signal to the plurality of scan lines S1 to Sn.

The data driver 30 is connected to each of the pixels of the display unit 10 through the plurality of data lines D1 to Dm. The data driver 30 receives an image data signal DATA 1, and transmits the received image data signal DATA1 to corresponding data lines among the plurality of data lines D1 to Dm according to the data control signal CONT1.

The data control signal CONT1 is an operation control signal of the data driver 30 generated and transmitted by the controller 40.

The data driver 30 selects a gray voltage according to the image data signal DATA1 and transmits the selected gray voltage to the plurality of data lines D1 to Dm as a data signal.

The controller 40 receives image information IS input from the outside and an input control signal controlling a display of the image information IS. The image information IS contains luminance information about each pixel of the display unit 10, and the luminance has a predetermined number, for example, 1024=2¹⁰, 256=2⁸, or 64=2⁶ grays.

The input control signal transmitted to the controller 40 may include a vertical synchronization signal Vsync, a horizontal synchronization signal Hsync, a main clock signal MCLK, and a data enable signal DE.

The controller 40 may perform image processing on the input image information IS to make it suitable for the operational conditions of the display unit 10 and the data driver 30 based on the input image information IS and the input control signal.

The controller 40 may generate the image data signal DATA1 with an image processing process, to take account of deterioration compensation and luminance compensation, for the image information IS.

The controller 40 may generate light emission time information corresponding to each pixel 70, and store the generated light emission time information in the memory unit 42. The controller 40 may generate a deterioration control signal ICS by using the light emission time information. Subsequently, according to the deterioration control signal ICS, the controller 40 may read deterioration compensation information STREAM DATA stored in the compensation memory unit 60. The controller 40 may then generate the image data signal DATA 1 by using the deterioration compensation information STREAM DATA and the image information IS so as to compensate for the deterioration of the organic light emitting diode included in each pixel 70.

Data for restoring the deterioration compensation information STREAM DATA may be stored in the memory unit 42. For example, offset data and section interval data corresponding to header bits of the deterioration compensation information STREAM DATA may be stored in the memory unit 42.

The controller 40 may restore the deterioration compensation information STREAM DATA by using the offset data and the section interval data stored in the memory unit 42.

The controller 40 transmits a scan control signal CONT2 to the scan driver 20 to control the operation of the scan driver 20. The controller 40 generates a data control signal CONT1 to control the operation of the data driver 30, and transmits the generated data control signal CONT1 to the data driver 30 together with the image data signal DATA1, which may be processed through the image processing method described above.

The controller 40 may control the driving of the power source voltage supply unit 50. For example, the controller 40 may be connected to an EN terminal of the power source voltage supply unit 50 and transmit a driving signal EN to the power source voltage supply unit 50.

The power source voltage supply unit 50 supplies a power source voltage stored in an outside or inside storage device for the driving of each pixel of the display unit 10.

The power source voltage supply unit 50 is electrically connected with each pixel through a power wire supplying a power source voltage to each pixel of the display unit 10. The power source voltage may be a first power source voltage ELVDD of a high level and a second power source voltage ELVSS of a lower level than that of the first power source voltage or a ground potential.

The compensation memory unit 60 stores deterioration compensation information corresponding to the light emission time of the pixels 70. For example, the deterioration compensation information might specify a change in some bits of the image data so as to compensate for deterioration in a pixel 70 in the display device for a given light emission time.

For example, a data stream in which deterioration compensation information about each pixel is compressed may be stored in the compensation memory unit 60 in response to the pixel light emission time of 1000 hours.

The controller 40 may generate the image data signal DATA1 further considering the deterioration compensation information in addition to the image information IS in a case where the pixel 70 emits light for 1000 hours.

FIG. 7 is a circuit diagram illustrating an example of a pixel structure included in a display unit of the display device according to the exemplary embodiment of FIG. 6. FIG. 7 illustrates a structure of the pixel PXij 70 connected to an i^{th} scan line Si and a j^{th} data line Dj as a pixel present in a region in which the i^{th} line Si crosses a j^{th} data line Dj among the plurality of pixels included in the display unit 10 of FIG. 6.

Referring to FIG. 7, the pixel 70 includes the organic light emitting diode OLED as an organic light emitting device and a pixel driving circuit for controlling the organic light emitting diode OLED. The pixel driving circuit includes a driving transistor M1, a switching transistor M2, and a storage capacitor Cst.

FIG. 7 representatively illustrates a case in which the pixel structure includes two transistors and one capacitor, but the pixel circuit structure of the display device is not limited to this structure, and may be differently configured.

The driving transistor M1 in the pixel 70 of FIG. 7 includes a gate electrode connected to a drain electrode of the switching transistor M2, a source electrode connected to a first power source to receive the first power source voltage ELVDD, and a drain electrode connected to an anode electrode of the organic light emitting diode OLED.

The first power source voltage ELVDD is supplied to the source electrode of the driving transistor M1 through the power source wire connected to the power source voltage supply unit 50 as described with reference to FIG. 6.

The switching transistor M2 includes a gate electrode connected to the scan line Si, a source electrode connected to the data line Dj, and a drain electrode connected to the gate electrode of the driving transistor M1.

The storage capacitor Cst includes one electrode connected to the gate electrode of the driving transistor M1 and the other electrode commonly connected to the first power source transmitting the first power source voltage ELVDD together with the source electrode of the driving transistor M1. The storage capacitor Cst charges a data voltage according to the data signal applied to the gate electrode of the driving transistor M1, and maintains the charged data voltage after the switching transistor M2 is turned off.

The organic light emitting diode OLED includes an anode electrode connected to the drain electrode of the driving transistor M1 and a cathode electrode connected to a second power source transmitting the second power source voltage ELVSS. The second power source voltage ELVSS is supplied to the cathode electrode of the organic light emitting diode OLED through a power source wire connected to the power source voltage supply unit 50 as described with reference to FIG. 6. Depending on the case, the second power source voltage ELVSS may be a ground potential.

The driving transistor M1 and the switching transistor M2 configuring the pixel of FIG. 7 may be p-channel field effect transistors (PMOS). Accordingly, a gate-on voltage turning on the driving transistor M1 and the switching transistor M2 is a logic low level voltage, and a gate-off voltage turning off the driving transistor M1 and the switching transistor M2 is a logic high level voltage. In the pixel of FIG. 7, the driving transistor is the PMOS, but an n-channel field effect transistor NMOS may also be used.

Accordingly, in the pixel of FIG. 7, the driving transistor is turned on only when the data voltage applied to the gate electrode of the driving transistor M1 is transmitted with a lower value than that of the first power source voltage ELVDD transmitted to the source electrode of the driving transistor M1, so that a driving current IEL corresponding to the data voltage may flow to the organic light emitting diode OLED. The current quantity of the driving current IEL determines luminance of the pixel, and color coordinates of RGB pixels. Particularly, a path of the driving current to the organic light emitting diode OLED is formed only when a voltage Vgs corresponding to a difference between the gate electrode voltage and the source electrode voltage of the driving transistor M1 is equal to or larger than a threshold voltage Vth of the driving transistor M1.

An operation of the pixel circuit of FIG. 7 will now be described. First, when a scan signal corresponding to the gate on voltage is transmitted to the scan line Si, the switching transistor M2 is turned on, and transmits a voltage according to the corresponding data signal to a first node N1 through the data line Dj.

Then, the data voltage is applied to one electrode of the storage capacitor Cst connected to the first node N1, and the first power source voltage ELVDD is applied from the first power source connected with the other electrode of the storage capacitor Cst, so that the storage capacitor Cst is charged with a voltage corresponding to a difference between the voltages of the both terminals. That is, the difference between the voltages of the both electrodes of the storage capacitor Cst corresponds to a difference between the voltages applied to the gate electrode and the source electrode of the driving transistor M1, respectively, so that the storage capacitor Cst stores the voltage Vgs between the gate electrode and the source electrode of the driving transistor M1.

When the data voltage applied to the gate electrode of the driving transistor M1 is applied with a low level so that the voltage Vgs between the gate electrode and the source electrode of the driving transistor M1 is equal to or larger than a threshold voltage Vth of the driving transistor M1, the driving transistor M1 of the PMOS is driven to form the driving current path, and the organic light emitting diode OLED generates light corresponding to the current quantity. In this case, the data voltage applied to the gate electrode of the driving transistor M1 is transmitted through the data driver 30.

The accompanying drawings and the detailed description are only illustrative, and are used for the purpose of describing the present invention but are not used to limit the meanings or a scope described in claims. Therefore, the person skilled in the art may easily select and replace the exemplary embodiments. Further, those skilled in the art may omit a part of the constituent elements described in the present specification without deterioration of performance or add a constituent element for improving performance. In addition, those skilled in the art may change a sequence of the steps of the method described in the present specification according to a process environment or equipment.

What is claimed is:

1. A method of processing data in a display device for displaying an image, the method comprising:
dividing a plurality of data elements into a plurality of sections according to a distribution of the plurality of data elements;
generating a header corresponding to a section including a data element;
compressing the data element to a compressed data element by using an offset corresponding to the section including the data element and an interval of the section including the data element.

2. The method of claim 1, wherein
the dividing of the plurality of data elements into the plurality of sections includes:
selecting a reference value from the distribution of the plurality of data elements;
setting an interval of the section according to a degree of the distribution of the plurality of data elements; and
dividing the plurality of data elements into the plurality of sections according to the set interval of the section from the reference value.

3. The method of claim 2, wherein
the reference value is a value corresponding to an average value of the distribution of the data elements or a value corresponding to a maximum value of the distribution of the data elements.

4. The method of claim 1, wherein
the dividing of the plurality of data elements into the plurality of sections includes
dividing the plurality of data elements into the plurality of sections by choosing the reference value according to a compression rate of the data element.

5. The method of claim 1, wherein
the dividing of the plurality of data elements into the plurality of sections includes
dividing the plurality of data elements into the plurality of sections by choosing the interval according to a compression rate of the data element.

6. The method of claim 1, wherein
the dividing of the plurality of data elements into the plurality of sections includes:
choosing the interval such that the intervals of sections with larger data element distribution are smaller than the intervals of sections with smaller data element distribution.

7. The method of claim 1, wherein
the compressing of the data element into the compressed data element includes:
dividing a difference between a value of the data element and the offset by the interval of the section including the data element.

8. The method of claim 1, further comprising
storing the compressed data element such that the compressed data element is related to the header.

9. The method of claim 8, further comprising:
determining the offset and the interval of the section from the header; and
restoring the data element by using a value of the compressed data element related to the header, the offset, and the interval of the section including the data element corresponding to the compressed data element.

10. The method of claim 9, wherein
the restoring of the data element includes
restoring the data element by adding the offset to a value obtained by multiplying a value of the compressed data element and the interval of the section including the data element corresponding to the compressed data element.

11. A display device, comprising:
a display unit including a plurality of pixels emitting light according to a plurality of data signals;
a data driver configured to transmit the data signals through a plurality of data lines connected to the plurality of pixels;
a power source voltage supply unit configured to supply a driving voltage for driving the plurality of pixels;
a compensation memory unit configured to store one or more compressed data streams related to compensation data for each of the plurality of pixels; and
a controller configured to generate the data signal by receiving an image signal, determining a header field from the compressed data stream, reading from a memory unit restoration information corresponding to the header field, restoring the compensation data, and compensating the image signal and generating the data signal by using the restored compensation data.

12. The display device of claim 11, wherein
the restoration information includes offset data corresponding to the header field and section interval data corresponding to the header field.

13. The display device of claim 12, wherein
the controller restores the compensation data by adding the offset to a value obtained by multiplying a value corresponding to the compressed data stream and the section interval.

14. The display device of claim 11, wherein
the compressed data stream is compressed by dividing the compensation data into a plurality of sections according to a distribution of the compensation data, generating the header field corresponding to the section including the compensation data, and choosing an offset corresponding to the section including the compensation data and an interval of the section including the compensation data.

15. The display device of claim 14, wherein
the compensation data is divided into the plurality of sections according to section intervals obtained using a reference value, wherein the reference value is determined from the distribution of the compensation data, and section intervals are set according to a degree of the distribution of the compensation data.

16. The display device of claim 15, wherein
the reference value is a value corresponding to an average value of the distribution of the compensation data or a value corresponding to a maximum value of the distribution of the compensation data.

17. The display device of claim 14, wherein
the compensation data is divided into the plurality of sections by choosing the reference value according to a compression rate of the compensation data.

18. The display device of claim 14, wherein
the compensation data is divided into the plurality of sections by choosing the interval of the section according to a compression rate of the compensation data.

19. The display device of claim 14, wherein
the compensation data is divided into the plurality of sections by choosing the interval such that the intervals of sections with smaller distribution of the compensation data are larger than the intervals of sections with larger distribution of the compensation data.
